(19) United States
(12) Patent Application Publication
(10) Pub. No.: US 2010/0033951 A1
(43) Pub. Date: Feb. 11, 2010

(54) ELECTRICAL COVER PLATE WITH VISUAL ENHANCEMENT

(76) Inventor: CHRIS LUGINBUHL, Tolland, CT (US)

Correspondence Address: ALIX YALE & RISTAS LLP, 750 MAIN STREET, SUITE 1400, HARTFORD, CT, 06103, US

(21) Appl. No.: 12/561,352

(22) Filed: Sep. 17, 2009

Related U.S. Application Data
(63) Continuation-in-part of application No. 12/214,755, filed on Jun. 20, 2008.
Application No. 12/214,755 is a continuation of application No. 10/202,512, filed on Jul. 23, 2002, now abandoned.
(60) Provisional application No. 60/307,203, filed on Jul. 23, 2001.

(51) Int. Cl. F21V 33/00

(52) U.S. Cl. 362/95

(57) ABSTRACT

A switch plate has a central aperture to accommodate the actuator or an outlet socket for an electrical switch. At least one recess is formed in the switch plate. Photoluminescent material is inserted into the recess so that under low light or darkened conditions, the photoluminescent material indicates the location of the switch actuator or socket. In one embodiment, a pair of photoluminescent strips extend on opposite sides of the aperture.

### CROSS-REFERENCE TO RELATED APPLICATION

This application is a continuation-in-part of U.S. patent application Ser. No. 12/214,755 filed on Jun. 20, 2008, which is a continuation of U.S. patent application Ser. No. 10/202,512 filed on Jul. 23, 2002, which claims the priority of U.S. Provisional Patent Application No. 60/307,203 filed on Jul. 23, 2001, the disclosures of which applications are incorporated herein in their entirety.

### BACKGROUND

This disclosure relates generally to devices for locating switches. More particularly, this disclosure relates to devices for locating switches during dark and/or low light conditions.

A recurring problem of modern life is to readily locate switches, and particularly a light switch, when the surrounding area is dark. Conventional techniques which have been employed to assist in locating light switches have involved illuminating the switches with low level light and/or directing a low level light to the area of the switch panel. While such devices have functioned in an advantageous fashion to facilitate location of a switch during low light conditions, a principal deficiency for such devices resides in the fact that such switches require a constant current and, therefore, are not energy efficient. Another problem with such devices is that they do entail installation time and cost, which in some cases mitigates against employing such devices. The disclosed device generally incorporates materials, which have the property of photoluminescence. Photoluminescence is a property in which light exposure causes the material to fluoresce and/or phosphoresce. This photoluminescence property can cause materials to glow in the dark.

### SUMMARY

Briefly stated in a preferred form, a new and improved device may be relatively easily mountable in conjunction with a light switch to provide a ready means for locating the switch in dark conditions through the use of photoluminescent materials.

The new and improved means for readily locating a light switch during dark conditions does not require electrical power or a battery power source since it incorporates the use of photoluminescent material.

The new and improved device can be manufactured and installed in an efficient and low cost manner to provide a highly reliable device for locating a light switch.

The device achieves the above stated features by the utilization of photoluminescent materials. The photoluminescent material may be molded or otherwise formed into structures that can be incorporated in or affixed to existing cover plate structures associated with electrical assemblies such as switch and plug socket outlets. The photoluminescent material may also be painted, dyed, or otherwise coated or impregnated in or onto materials. The materials may be fixed through existing mechanical structure or adhesive means to the switch assembly.

### BRIEF DESCRIPTION OF THE DRAWINGS

FIG. 1 is a front view of one embodiment of a switch enhancement device installed on a light switch plate;

FIG. 2 is a front view of a second embodiment of a switch enhancement device installed on a light switch plate;

FIG. 3 is a front view of a third embodiment of a switch enhancement device installed on a light switch plate;

FIG. 4 is a front view of a fourth embodiment of a switch enhancement device installed on a light switch plate;

FIGS. 5A through 5C are front views of various designs of switch enhancement devices, each of which are installed on a light switch plate;

FIGS. 6A through 6F are front views of various designs, each of which are installed on a portion of a light switch plate;

FIGS. 7A and 7B are front views of animal designs, each of which can be installed on a portion of a light switch plate;

FIGS. 8A and 8B are front views of a ships wheel design and a sign design carrying a trade name on it, each of which can be installed on a portion of a light switch plate;

FIG. 9 is a front view, partly in diagrammatic form, of a switch plate incorporating a photoluminescent switch indicator;

FIG. 10 is a front view, partly in diagrammatic form, of another switch plate incorporating the photoluminescent switch indicator;

FIGS. 11A through 11C are front views of electrical cover plates incorporating tandem forms of photoluminescent indicators schematically shown as solid black areas;

FIGS. 12A-12C are front views of electrical cover plates incorporating tandem forms of photoluminescent indicators schematically shown as solid black areas;

FIGS. 13A-13C are front views of electrical cover plates incorporating series forms of photoluminescent indicators schematically shown as solid black areas;

FIGS. 14A-14C are front views of electrical cover plates incorporating frame forms of photoluminescent indicators schematically shown as solid black areas;

FIGS. 15A-15C front views of electrical cover plates incorporating fanciful forms of photoluminescent indicators schematically shown as solid black areas;

FIGS. 16A-16C are front views of electrical cover plates which substantially formed of photoluminescent materials schematically illustrated as solid black areas; and

FIG. 17 is an enlarged elevational view of a screw for an electrical plate and having a photoluminescent composition.

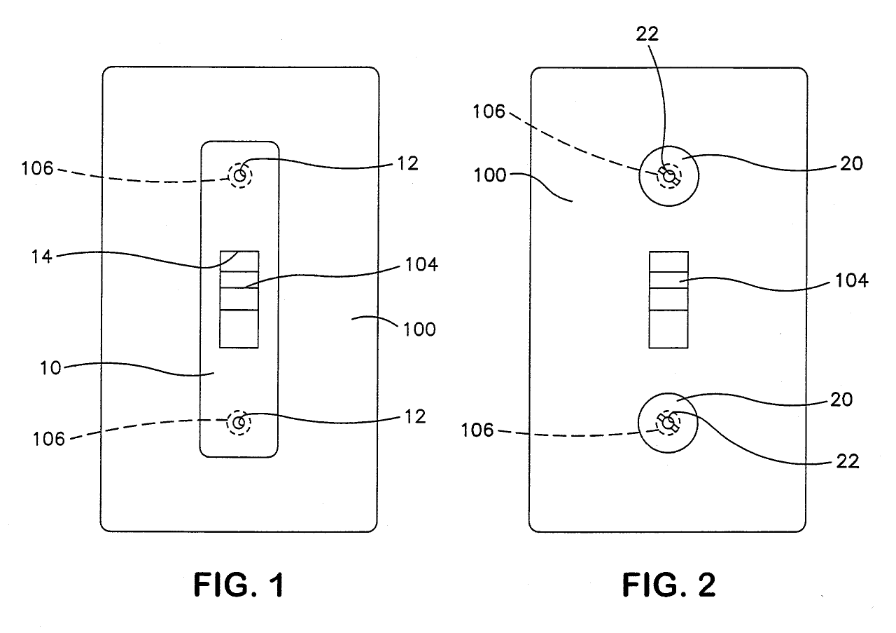

### DETAILED DESCRIPTION OF THE PREFERRED EMBODIMENTS

With reference to the drawings wherein like numerals represent like parts throughout the figures, a switch enhancement device may be configured in several different embodiments. In one embodiment, the switch enhancement device is easily installed to an existing light switch and functions as a switch locator by emitting a glow without requiring any electrical power.

The switch device 10 in one preferred form is a plate, which replaces or slips over a conventional switch plate 100 which may have numerous forms and functions. It should be understood that switch plate 100 as illustrated is representative of numerous forms and configurations and should not be deemed a limitation of the invention. The plate 10 is made from a photoluminescent material. The switch plate 10 includes a pair of recessed openings 12 which are spaced a distance equal to the fastener openings 102 of the conventional switch plate 100. The switch plate 100 has an enlarged central aperture 14 which is dimensioned to slip over and around the conventional light switch toggle or actuator 104. The plate may be relatively easily mounted in place by removing the conventional threaded fasteners 106 which secure the switch plate 100 in position, inserting fasteners 106 through the openings 12 and securing the fasteners 106 to the threaded anchors (not illustrated) of the switch assembly.

With reference to FIG. 2, a second switch enhancement embodiment 20 is configured in the form of a flat circular disc or washer which includes a central opening 22. The conventional threaded screw 106 of the switch plate is removed and the fastener is inserted through the opening so that the fastener head captures the washer 20 and secures it in position against the switch plate 100. Preferably, two photoluminescent washers 20 are employed. This embodiment may be modified so that the area surrounding the central opening is shaped to resemble a variety of objects, such as but not limited to, animals, vehicles, structures, and the like.

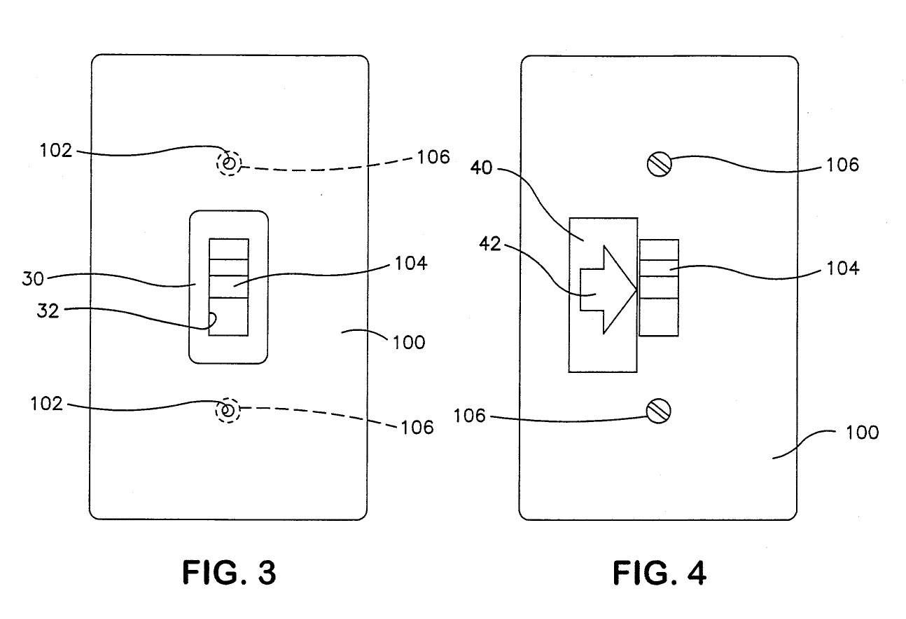

A third embodiment of a light switch enhancement device in accordance with the present invention is illustrated in FIG. 3 as device 30. Device 30 is also manufactured from photoluminescent material. The device 30 includes an adhesive backing (not illustrated) and is configured in a frame like structure having a central aperture 32 which fits around a conventional light switch toggle or actuator 104. The device 30 may be easily installed on the light switch by pressing it against the switch plate.

The composite material which may be employed for each of the embodiments 10, 20, 30 is a plastic material which contains a photoluminescent pigment. One such pigment is marketed under the LumiNova® name by United General and Chemical Corporation, 110 Valley Brook Avenue, Lindhurst, N.J. 07071. Such a pigment is added into the plastic material. During dark or low light conditions, the material will glow and accordingly, the light switch may be located during dark conditions.

It will be appreciated that the locator device may also be formed into various additional devices such as zipper pulls and tags (not illustrated). The products may be injection-molded products which can be manufactured in a highly cost-effective manner.

With reference to FIG. 4, a fourth embodiment of the switch enhancement device 40 is a tape or film printed with photoluminescent ink and fastened to the switch plate by adhesive (not illustrated). The tape 40 may include arrows 42 or other locating indices formed by the photoluminescent ink.

Alternatively, the tape may also be printed with photoluminescent ink which forms a frame (with a cutout) to be placed around the switch actuator or toggle.

Alternatively, the switch plate 100 may be impregnated with photoluminescent pigments or a central rim of pigment around the inner circumferential border surrounding the switch toggle or actuator.

In one preferred embodiment the switch plate 100 may be formed from photoluminescent material or be painted or dyed with photoluminescent material.

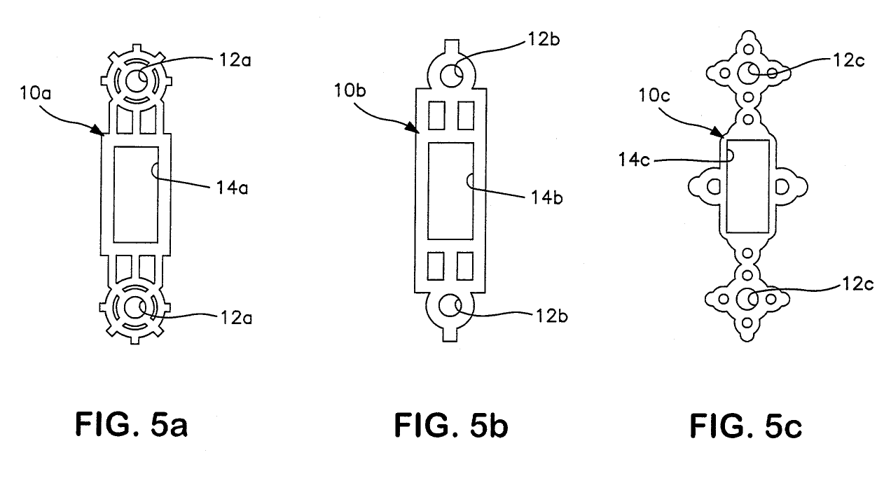

With reference to FIGS. 5A, 5B and 5C, a modified embodiment of switch device 10 may be configured in various fanciful design embodiments 10a, 10b and 10c these switch devices are each secured to the conventional switch plate via the switch plate fasteners 106. In this regard, each of the switch plates 10a, 10b and 10c includes an enlarged central aperture 14a, 14b and 14c which as mentioned, to slip over and around the conventional light switch toggle or actuator 104. In addition, each of switch plates 10a, 10b, and 10c includes a pair of recessed openings 12a, 12b and 12c, which are, spaced a distance equal to the fastener openings 102 of the conventional switch plate. Each of the switch devices 10a, 10b and 10c is formed from a photoluminescent material and therefore, facilitates location of the light switch.

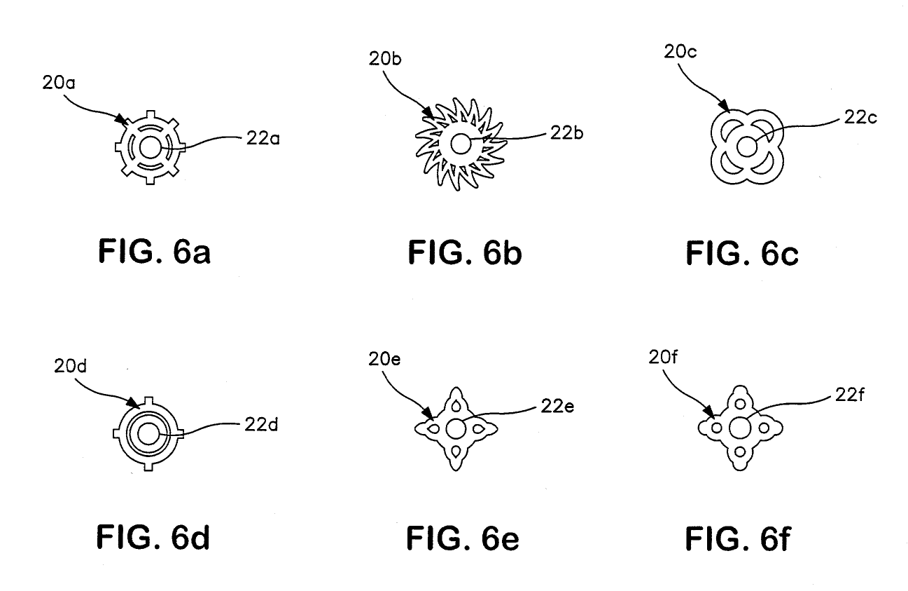

With reference to FIGS. 6A through 6F, switch enhancement embodiments 20a through 20f are similar in function to that of switch enhancement 20, but are further configured in the form of fanciful designs. Each of the switch enhancement devices includes a central opening 22a through 22f which is dimensioned to receive the switch plate fastener for securing the locator device to the switch plate. The switch enhancement devices 6a through 6f are also formed from a photoluminescent material and accordingly, the devices also function to facilitate location of the switch.

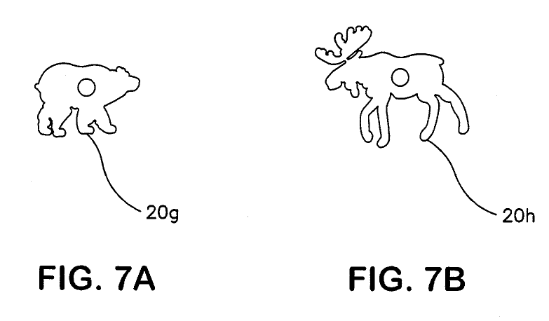

With reference to FIGS. 7A and 7B, switch enhancement embodiments 20g and 20h are similar in function to that of switch enhancement 20, but are further configured in the form of animal designs.

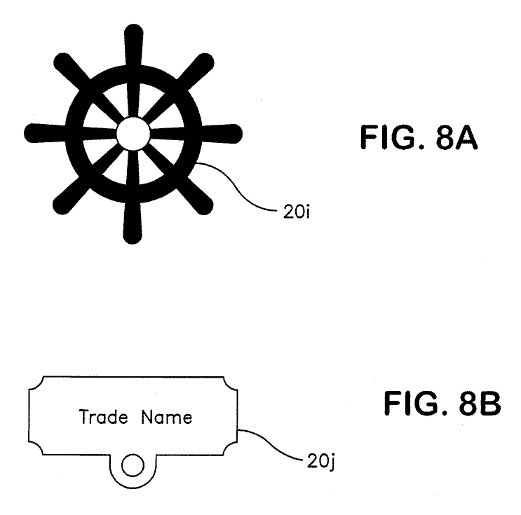

With reference to FIGS. 8A and 8B, switch enhancement embodiments 20i and 20j are similar in function to that of switch enhancement 20, but are further configured in the form of a ships wheel, 20i, and a sign bearing a trade name 20j.

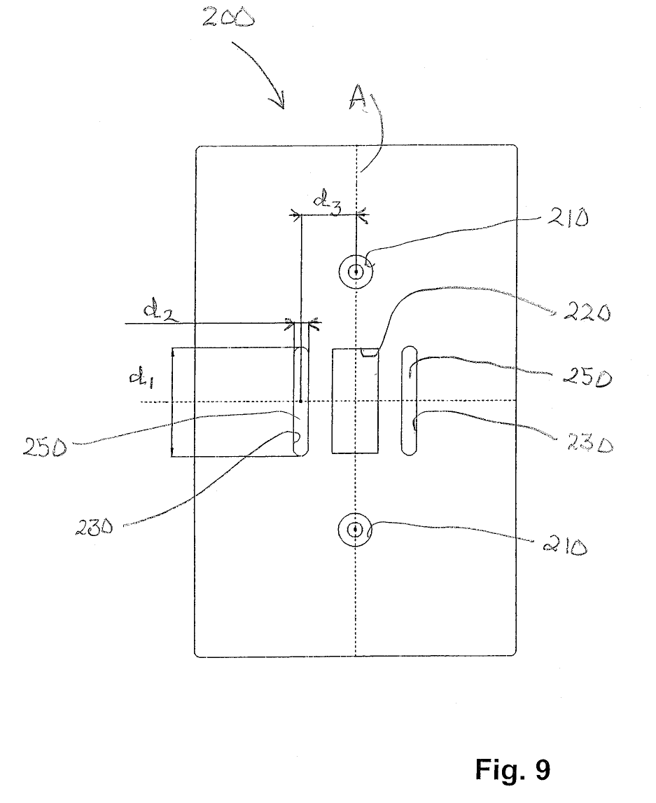

With reference to FIG. 9, a switch cover plate is generally designated by the numeral 200. The switch cover plate 200 has a pair of openings 210 which are formed to receive fasteners for fastening the switch plate to the switch assembly. The switch plate includes a central rectangular aperture 220 which accommodates a switch toggle or actuator (not illustrated). A pair of oblong recesses 230 are formed in parallel relationship to the opposed elongated sides of the aperture. In one preferred embodiment, the recess dimensions d₁ and d₂ are respectively 1.00 and 0.14 inches. The recesses 230 are offset from the central longitudinal axis A through the switch plate by a distance d₃ of 0.50 inches. The recesses are preferably shallow and may be formed by machining or by a mold process. For metal cover plates, the recesses 230 may be formed by milling or metal forming processes.

The recesses are filled with photoluminescent material 250 which may be accomplished in several ways. In one form, the photoluminescent material 250 is applied or inserted by an injection molding process. Alternatively, the photoluminescent material 250 may be pre-configured in solid rod-like inserts which are complementary with the recesses. The rods are then dropped into the recesses and secured by adhesive. In another method, inserts conformed with the recesses are formed of photoluminescent materials and snapped into the recesses and secured by an interference fit.

It will be appreciated that under darkened or low light conditions, the photoluminescent material will glow sufficiently to indicate the location of the switch actuator.

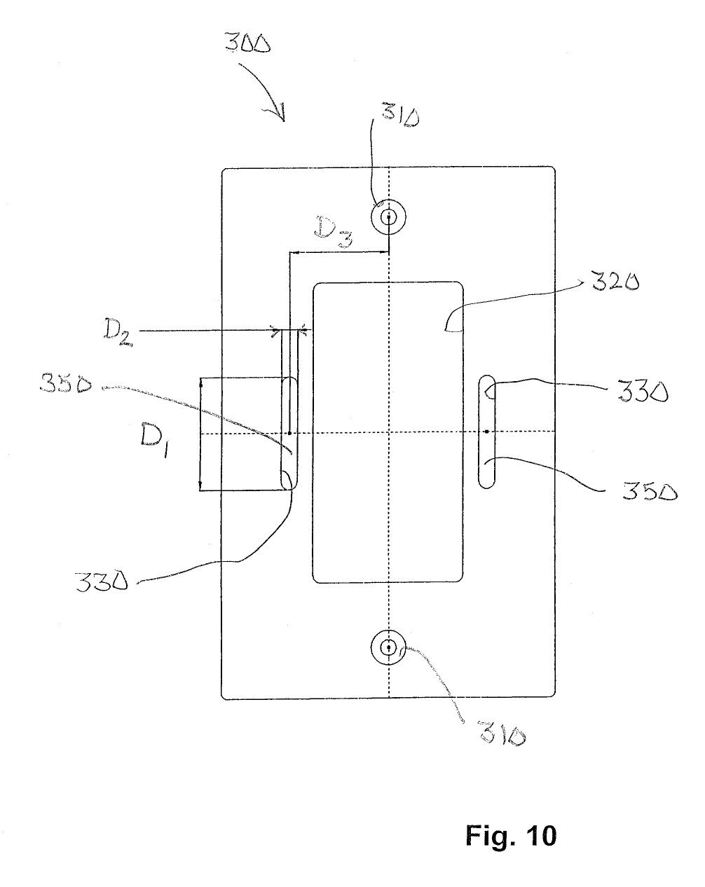

With reference to FIG. 10, a switch plate 300 which has an enlarged central substantially rectangular aperture 320 is formed. The switch plate 300 also includes a pair of fastener openings 310. A pair of oblong recesses 330 spaced from the opposed edges of the central openings are formed in the switch plates. The recesses may be in the form of shallow grooves and have dimensions D₁ and D₂ preferably respectably 1.00 and 0.14 inches. In one form, the central axis elongate longitudinal axis of each of the recesses is offset from the central longitudinal axis A by a distance D₃ of 0.875 inches. Photoluminescent material 350 is placed in the recesses and secured by adhesive or, as applicable, an interference fit. Under darkened or low light conditions, upon mounting the switch cover plate to the switch assembly, the photoluminescent material would indicate the location of the switch actuator.

The photoluminescent material for the inserts may be an active photoluminescent agent loaded into a thermoplastic resin such as ECM product code PP4122 Max Glow PP of EMC Plastics, Inc. of Worcester, Mass. The material has a composition which preferably exceeds 40% active photoluminescent additive. The preferred active photoluminescent material is strontium based. The material will recharge with each exposure to daylight or artificial light.

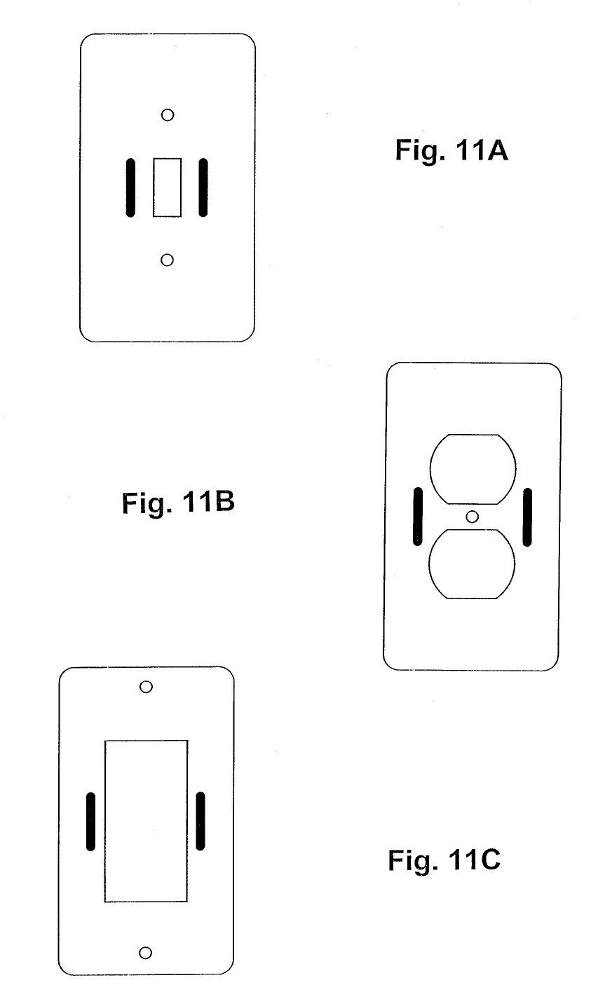

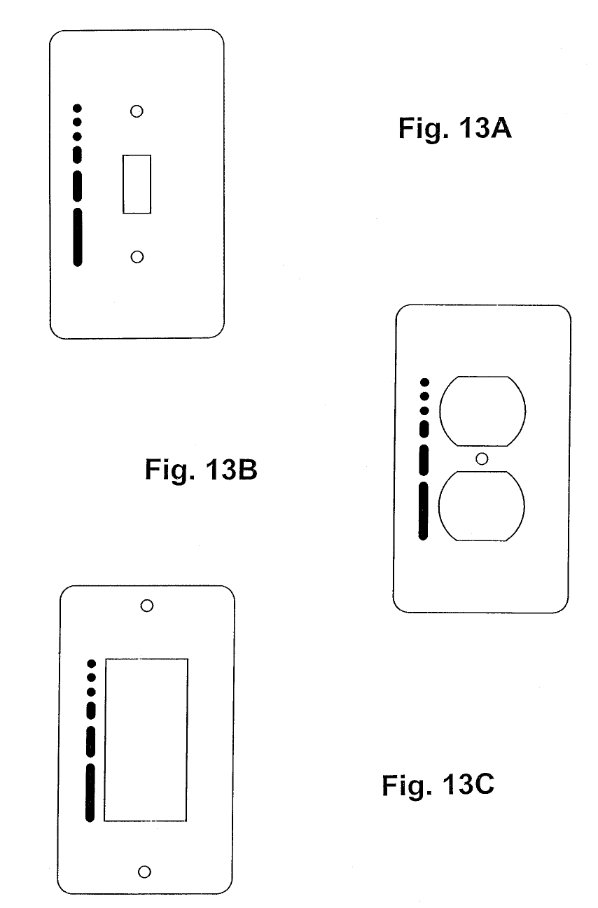

FIGS. 11A through 14C illustrate other forms of recesses which are filled with photoluminescent material which may also be employed to indicate the location of a switch or plug under darkened or low light conditions. The front surface of the photoluminescent material is schematically shown as a solid black to represent the area of glow under low light conditions. It is important to note that the amount of photoluminescent material is employed in an economical manner to minimize the cost of the electrical cover plates since the photoluminescent material is somewhat expensive.

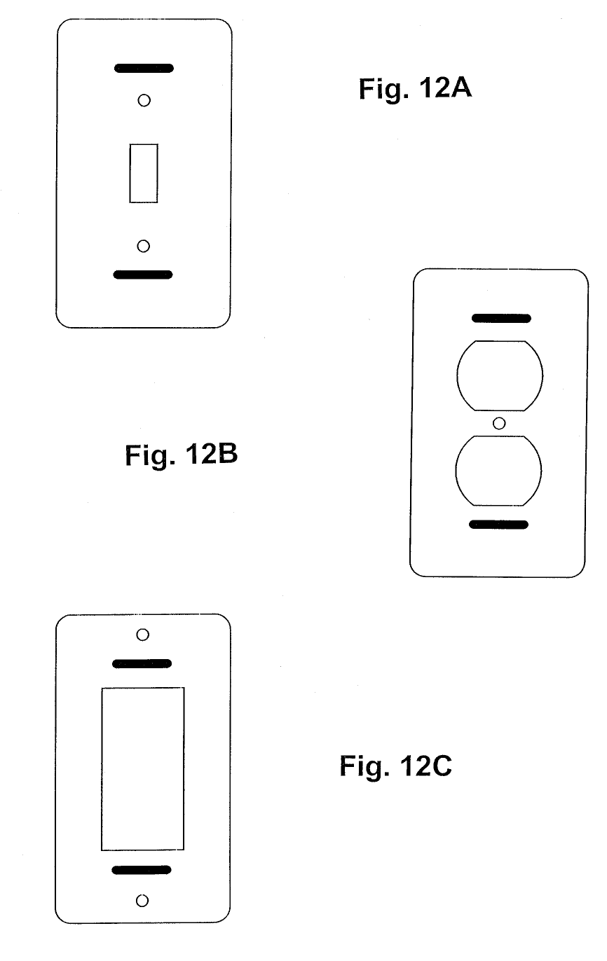

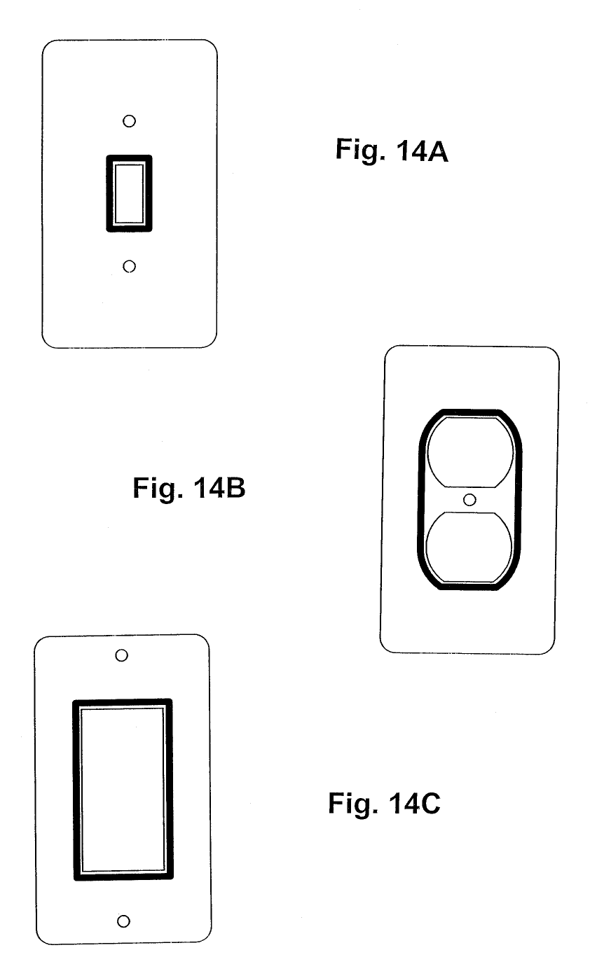

Various forms of photoluminescent indicators for electrical plates are possible. For example, FIGS. 11A-11C illustrate tandem vertical photoluminescent indicators. FIGS. 12A-12C illustrate tandem horizontal photoluminescent indicators. FIGS. 12A-12C illustrate serial linear irregular dot form of photoluminescent indicators for electrical cover plates. FIGS. 14A-14C illustrate frame-type photoluminescent indicators for cover plates.

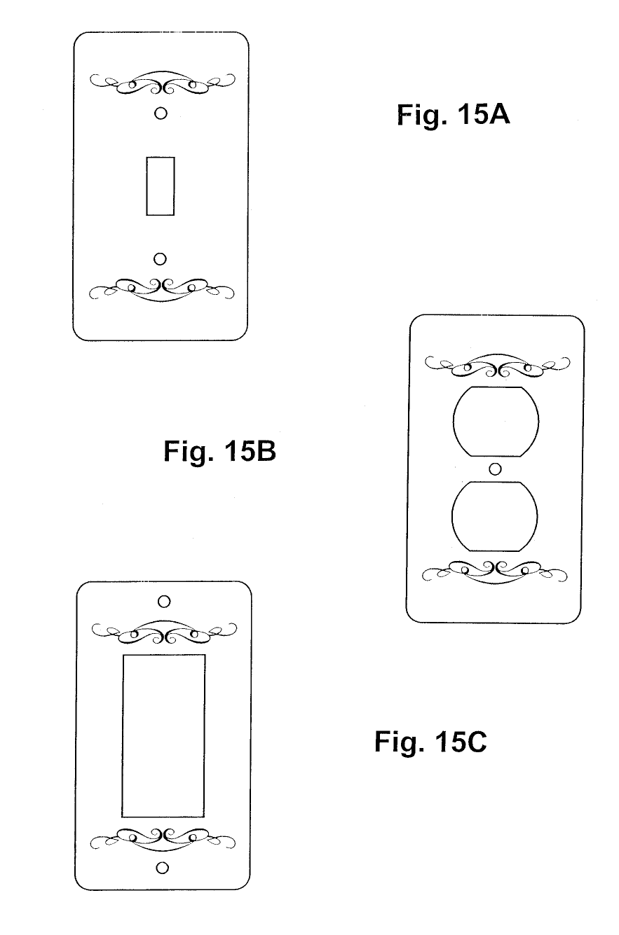

With reference to FIGS. 15A-15C, fanciful photoluminescent indicators are provided by applying photoluminescent paint to the various electrical plates.

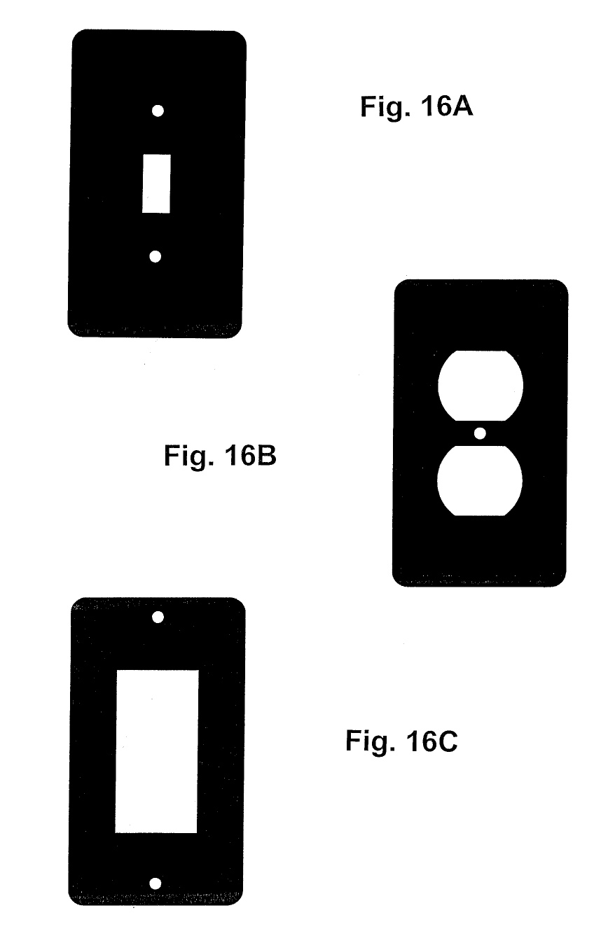

In some forms, the entire electrical plate may be formed of photoluminescent material or the front cover portion of the plate may be formed of photoluminescent material such as illustrated in FIGS. 16A-16C.

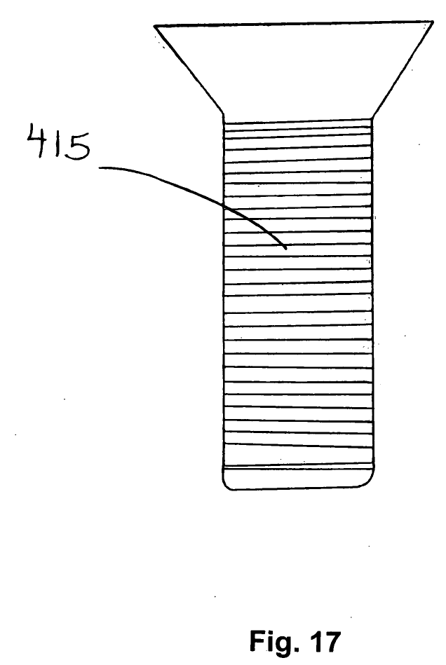

In certain embodiments, the plate may be a cover plate for an electrical plug or socket and the photoluminescent material positioned to indicate the plug socket, such as illustrated in FIGS. 11B, 12B, 13B, 14B, 15B and 16B. In addition, one or more screws 415 for a conventional cover plate may be formed of photoluminescent material, such as illustrated in FIG. 17.

It should be appreciated that numerous other possible designs and configurations of the light switch enhancement devices and electrical cover plates may be provided.

1. A cover plate for an electrical switch assembly comprising:
a plate with a central aperture for a switch actuator;
a recess formed in said plate adjacent to and spaced from said central aperture; and
a photoluminescent material disposed in said recess so that when said plate is in an ambient low light condition, said material generates a glow which indicates the location of a switch actuator at or in said aperture.

2. The cover plate of claim 1 wherein the central aperture defines a longitudinal axis and said recess has an elongated shape parallel to said longitudinal axis.

3. The cover plate of claim 1 further comprising a second recess wherein each said recess is formed at opposite locations spaced from said central aperture and each said recess is substantially identical in shape and substantially parallel to said longitudinal axis.

4. The cover plate of claim 3 wherein the aperture defines a central longitudinal axis and each said recess has an oblong shape.

5. The cover plate of claim 1 wherein said plate and said aperture each have a substantially rectangular shape

6. A cover plate comprising:
a plate with a central aperture for a switch which plate has an elongated shape and defines a central longitudinal axis;
a pair of recesses formed in said plate spaced from said central aperture and disposed generally parallel to said longitudinal axis;
a photoluminescent material disposed in each said recess so that when said plate is in an ambient low light condition, said material generates a glow which indicates the location of a switch actuator at said aperture.

7. The cover plate of claim 6 wherein each said recess has an elongated oblong-type shape.

8. The cover plate of claim 6 wherein each said recess extends approximately 1 inch.

9. The cover plate of claim 6 wherein said central switch aperture has a substantially rectangular shape.

10. A plate for covering an electrical switch or outlet comprising:
a plate with an aperture;
a recess formed in said plate;
a photoluminescent material disposed in said recess and oriented so that when said plate is in an ambient low light condition, said material generates a glow which indicates the location of said aperture.

11. The plate of claim 10 wherein said photoluminescent material has the shape of a linear series of irregular dots.

12. The plate of claim 10 wherein said photoluminescent material has the shape of an elongated rod.

13. The plate of claim 10 wherein there are a pair of recesses which are symmetric about the central aperture and cooperate to indicate the location of said aperture when said plate is in said low light condition.

14. The plate of claim 10 wherein said recess is an opening for a screw and said photoluminescent material is in the form of a screw.
